(19) United States
(12) Patent Application Publication
(10) Pub. No.: US 2004/0024732 A1
(43) Pub. Date: Feb. 5, 2004

(54) Constructing a component management database for managing roles using a directed graph

(76) Inventors: Bryan Klisch, Seattle, WA (US); John Vogel, Mercer Island, WA (US)

Correspondence Address: JAMES L DAVISON, 19822 226TH AVENUE N.E., WOODINVILLE, WA, 98072

(21) Appl. No.: 10/221,514

(22) PCT Filed: Apr. 2, 2001
(86) PCT No.: PCT/US01/10726

(51) Int. Cl. G06F 7/00

(52) U.S. Cl. 707/1

(57) ABSTRACT

A system and method of monitoring and controlling a variety of hardware and software components in both a computer system and in a linked set of multiple computer systems (70, 72, 74). The components are imbued with methods that allow them to communicate with a component management database [FIGS. 1 and 14] that in turn is used by a configuration manager [40]. The components can describe their parameters, their relationships with other components, and their performance metrics. With this information the configuration manager can monitor and control these components to maximize the availability of the system or the network.

### FIELD

The present invention is in the field of increasing the availability of computer systems and networked computer systems.

### BACKGROUND

This application is entitled to the priority of the filing date Apr. 4, 2000 based on Provisional Application No. 60/194,375.

The current generation of interface busses are designed to a standard that permits the hardware components inserted into those busses to be added and removed (inserted and extracted) without having to remove power first. When an insertion or extraction event occurs a signal is generated noting the event. Until now there has been no solution that can use this event signal to maintain the operational integrity of the system when used across multiple operating systems and multiple hardware platforms. The present invention provides such a solution. By the means of an application that determines the interdependencies of the software and hardware components of a system, and that monitors the operational status of these components, and can manage the shifting of those resources, as required, to maximize the performance of the system, then the capabilities of the standard allowing insertion and extraction of resources while maintaining a powered up environment can be finally fully utilized. This solution is extensible to manage and shift resources regardless of the type of hardware and software resources that reside on the system.

The situation becomes more complicated in a client/server networked environment, which although may have lower costs than mainframe systems, also have increasingly complicated management and support issues. These issues are increased by having multiple applications spread across multiple hardware systems. Administrators trying to keep network availability at a high level need increasingly more sophisticated tools to both monitor network performance and correct problems as they arise. The present invention provides those tools.

### SUMMARY

By maintaining a database of system components and their various interdependencies and then monitoring the performance and operational status of those components it is possible to manage the system to provide a level of high system availability thereby maximizing the system “up time”. The components themselves use a distributed messaging system to communicate with each other and a dynamic configuration manager that maintains the database of system components. Upon system initialization the dynamic configuration manager retrieves self-describing messages from the components in the system. These messages contain the status and interdependencies of each component. While the system is operational any change in the components status is communicated to the dynamic configuration manager that then has the responsibility to shift the resources available to it to maximize the availability (up time) of the system. This same type of management is also available in multiple computer networked systems wherein each computer system comprising hardware, operating systems, applications and communication capabilities is also referred to as a “nodes”. In this case if the microprocessor running the dynamic configuration manager becomes itself unavailable then the dynamic configuration manager activities may be transferred to another microprocessor node on the network.

### BRIEF DESCRIPTION OF THE DRAWINGS

The features of the present invention which are believed to be novel, are set forth with particularity in the appended claims. The invention, together with further objects and advantages, may best be understood by reference to the following description taken in conjunction with the accompanying drawings, in the several Figures of which like reference numerals identify like elements, and in which:

FIG. 1 shows a flow chart of how the component management database is used.

FIG. 2 shows how the component management instructions interface with the operating system in a web server.

FIG. 3 shows a state machine reacting to an insertion or extraction event.

FIG. 4 shows how the information from a component management database may be displayed.

FIG. 5 shows a directed graph with critical and non-critical dependencies.

FIG. 6 shows how information from a component management database may be used to generate an event.

### DETAILED DESCRIPTION OF THE INVENTION

Management software needs to intimately understand what managed components are installed in the system and their relationships. The software should dynamically track the topology of these managed components as well as the individual configuration of each component. To address the wide range of components within a typical system, the software must recognize and manage CPU modules, I/O cards, peripherals, applications, drivers, power supplies, fans and other system components. If the configuration changes, the system should take appropriate action to load or unload drivers and notify other components that may be affected by the change. The interdependence of the various components on each other is vital information for building a highly available system.

In order to be effectively managed, components must be represented in one centralized, standard repository. This component management database should contain information on each component as well as the relationships that each component has with each other. For example, a daughterboard that plugs into an I/O card represents a parent-child relationship. The component table should also be able to identify groups of components that share responsibility for a given operation. Finally, the component management database should store information regarding the actions that need to be taken for 1) a component that is removed from the system, or 2) a component that is dependent on another component that has been removed from the system.

As managed components are added and removed, the system needs a mechanism for tracking these events. If the type and location of a component is fixed, the system can poll the component on a regular basis to determine its presence. However, if the type and location of the component varies, then the system needs a more intelligent way of identifying the component. In the preferred embodiment, the component should be able to identify itself to the system and describe its own capabilities, eliminating the need for the management software to have prior knowledge of the component's capabilities. This mechanism is an essential enabler for hot-swap and transient components.

To accomplish this, components can be enabled with publish and subscribe capabilities that register with a dynamic configuration manager. When a component is loaded or inserted into the system, it broadcasts its identity to the configuration manager. The configuration manager then queries the component to determine its type and capabilities. The component is then entered into the list of managed components and appropriately monitored. Each different component or each class of component may have its own set of methods that may be called. When the component is removed, the configuration manager triggers the appropriate action. For a card, this could include unloading the drivers and transferring operation to a redundant card.

The management software should provide a mechanism for system components such as cards, drivers and applications to communicate with each other either within the system or with components in other systems within the cluster. A distributed messaging service provides the transport for these messages. This service uses a “publish and subscribe” model. The software provides client, server and a routing functionality. To send a message, the component passes messages through the management software. When a new publisher appears, all of the subscribers are notified that a new publisher has registered. When a new subscriber appears, all the publishers are notified that a new subscriber has registered. The messaging service provides a global event class and event name that enable messages to be routed across “bridged” networks. Instead of using broadcast packets that may be blocked by firewalls and routers, the messaging service sets up connections with each system. These individual system connections let the message be routed to the correct system without interference.

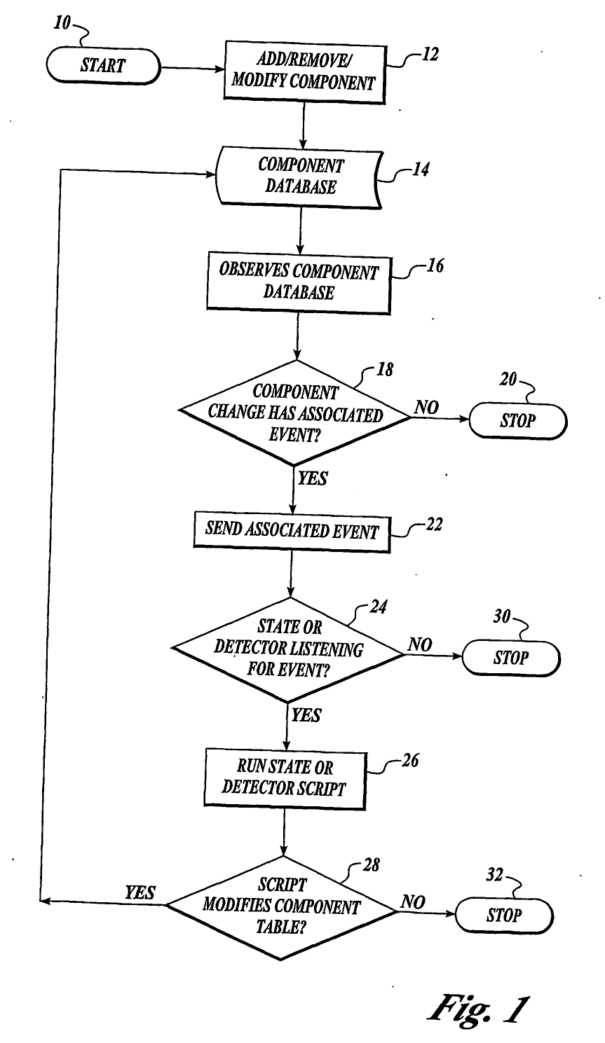

FIG. 1 Shows a high level view of how components are managed. Whenever a component is added, modified or removed 12 the component management database 14 is updated to reflect that fact. This database is constantly observed for changes that meet a predetermined criterion 16. When the component change observed does meet that criteria an event 22 may be sent (published) to those states or detectors 24 that are listening for that event (subscribing to the event). If the event being subscribed to then meets another predetermined criteria a state or detector script 26 is run. This script then has the capability to modify the component management database 14.

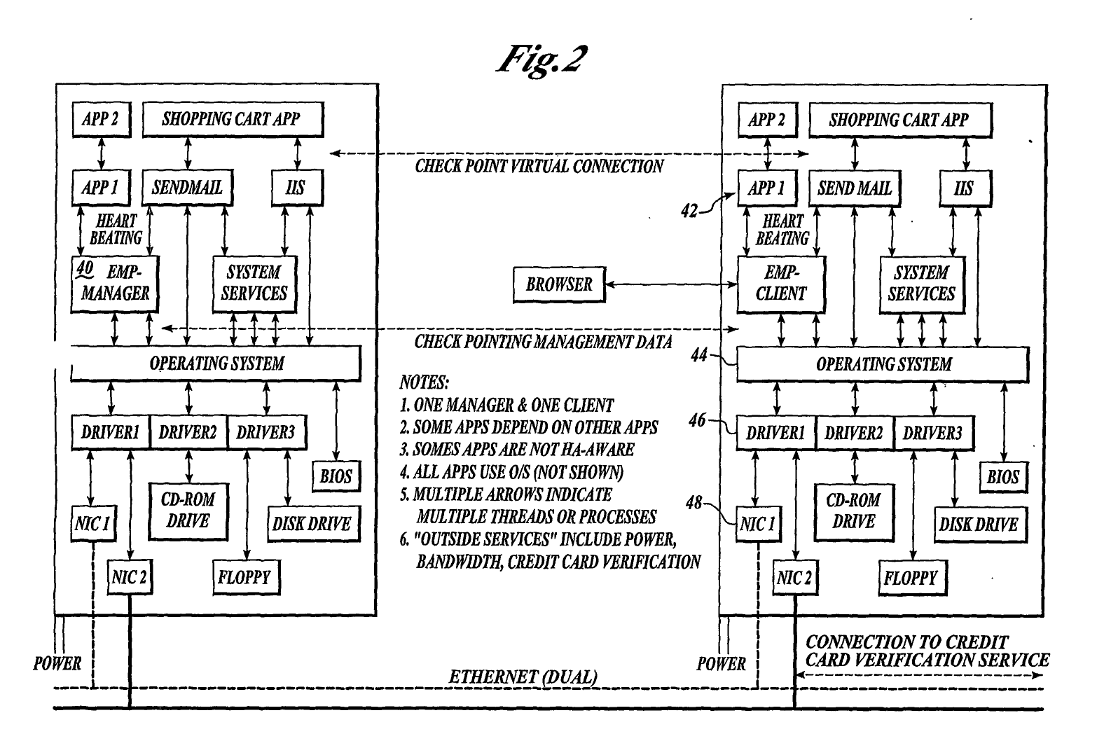

FIG. 2 shows the preferred embodiment of the invention as it may be used in a web merchant application. The component management database, configuration management and role management capabilities are provided by the EMP-manager block 40. The EMP (embedded management process) is an application running on top of the operating system 44. The EMP has a number of APIs (Application Program Interfaces) that provides functions that a system can call to implement the component management, configuration management and role management process. The applications 42 are written using those APIs. Driver 46 software that provides the interface to other pieces of hardware may also be written to take advantage of functions provided by the APIs. Boards 48 such as the Network Interface Cards (NIC) that are controlled by the drivers 46 can also be integrated into the component management database and managed appropriately using the predetermined operating rules.

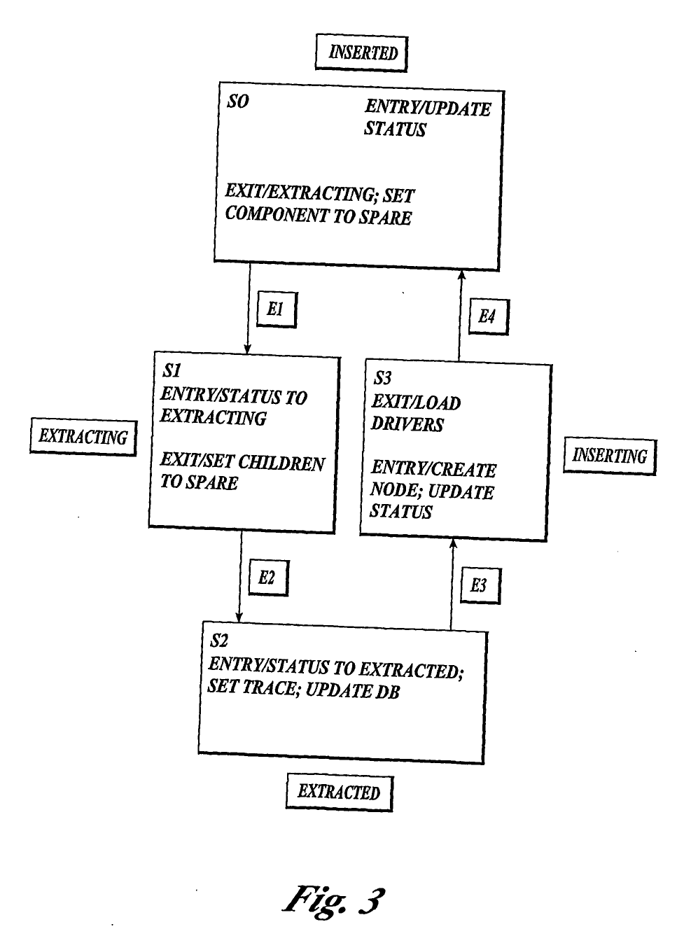

FIG. 3 shows a state machine, which is an abstraction of the events that a component may react to. In addition to reacting to events, a state machine may generate other actions and responses besides the ones that triggered its reaction. The reaction that is generated is determined by the state that the component is in when it receives the event. State SO exists whenever a card is presently inserted into the proper operating system bus. When the card starts to be removed from the bus (extracted) event E1 occurs. An instruction is sent to the component management database to set its status to “extracting”. A follow-on instruction is sent to change the status of its children (the components that depend on the card for their correct operation) to “spare”. Event E2 occurs when the card is extracted. The state of the card is now defined as “extracted” and an instruction is sent to the database to reflect that status and a “trace” command is set. The “trace” command is a piece of data that remains in memory to reflect the sequence of operations that effect the components listed in the database. It is possible to historically resurrect the history of what occurred by examining the trace events that have been logged.

The insertion event E3 is very similar to the extraction event whereby the instructions issued by the state now reflect its desire to be placed into the database and to issue requests that the drivers necessary to operate the card again be loaded. Upon successful loading, the component requests that its database status be updated to reflect its presence and operation.

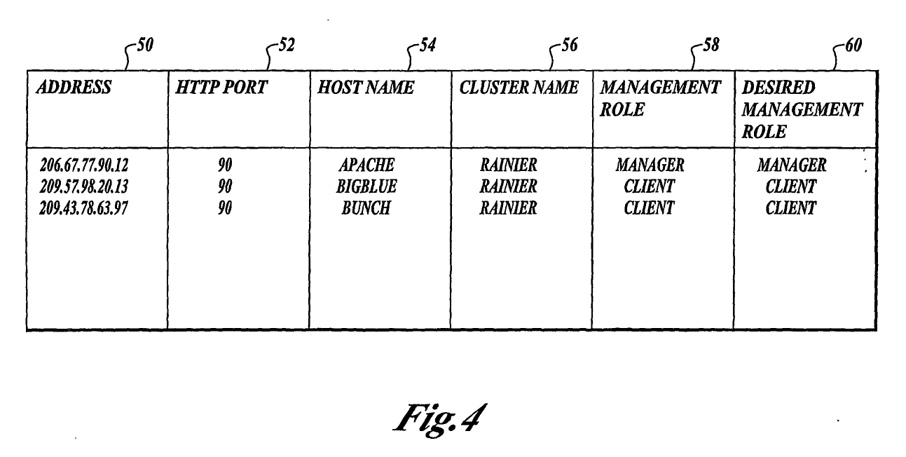

The configuration management database shown in FIG. 4 shows one of many ways the information residing in the database may be shown. The address field 50 of the database is the global IP address of the component listed. The IP address is used to implement the fact that this information may be used not only on a specific network but also across networks using the Internet. The communications protocol used to send and receive information across the networks, in the preferred embodiment, is TCP/IP. The preferred API to access the TCP/IP protocol is the sockets interface. An address using TCP/IP sockets consist of the Internet address (IP_address) and a port number 52. The port is the entry point to an application that resides on a host 54 (a networked machine). The database also gives the name of the cluster 56 (a collection of interconnected whole computers used as a single unified computing resource). Next is the management role 58 assumed by the host and the last field shown is the desired management role 60 that the system tries to obtain. In the preferred network embodiment the protocol used is HTTP (Hypertext Transfer Protocol) which establishes a client/server connection, transmits and receives parameters including a returned file and breaks the client/server connection. The language used to write the documents using the HTTP protocol is HTML. In the preferred embodiment a copy of the component management database information is generated by a small footprint Web server and made available to other nodes in the system. This web server runs on top of the operating system that is also running the component management database system. Information and messages that need to be sent across the network using the TCP/IP protocol are first translated into the Extensible Markup Language (XML) using tags specifically defined to identify the parameters of the components to be monitored and controlled. For example, the component management database may be maintained in the dynamic memory of the processor board, and a duplicate copy may be maintained on the computer's or network's hard drive and yet another copy or copies are send using the XML markup language to the client components on the other linked networks.

In the preferred embodiment of this invention, clusters of components may be managed by running th common component management database instructions on each branch of the cluster. This allows the cluster to be centrally managed. Each branch of the cluster can find each other and communicate across the network. To make a set of these instructions into a single entity, a single cluster name and communication port is assigned to them. As soon as the system is booted up, the instructions begin to broadcast their existence to each other. Once they are all communicating, they begin to select an overall cluster manager. The cluster manager may be preselected or selected dynamically by a process of nomination and “voting”. Once a cluster manager is selected then the other entities become clients of that manager. If no manager is selected, then a timing mechanism engages that selects the cluster manager from the group. This algorithm ensures that a cluster always has a suitable manager. If a new entity joins the cluster then all the other entities again join together to determine the most appropriate manager following preselected criteria. The managing cluster entity receives from the client entity its configuration information including among other things the communication port in which to send and receive information as to the functional status of the managed entity; the amount of time that the manager can allow between these status updates; the number of consecutive status updates that may be lost before the manager considers the client “lost”; and the event that the manager must issue when the client is determined to be “lost”. This and all the other pertinent information are stored in the cluster managers database. Each client also maintains a cluster database, which stores information about itself and the cluster manager.

Once the cluster manager has received this information from the clients it begins normal operation including maintaining a connection with the clients, monitoring the status of the clients and routing published cluster events to the subscribing applications. In turn the clients begin their normal operation including send database information to the manager, responding to status requests, detecting if the cluster manager is lost, participating in the election of a new cluster manager if this occurs, and publishing messages to be routed by the cluster manager to the subscribing entities.

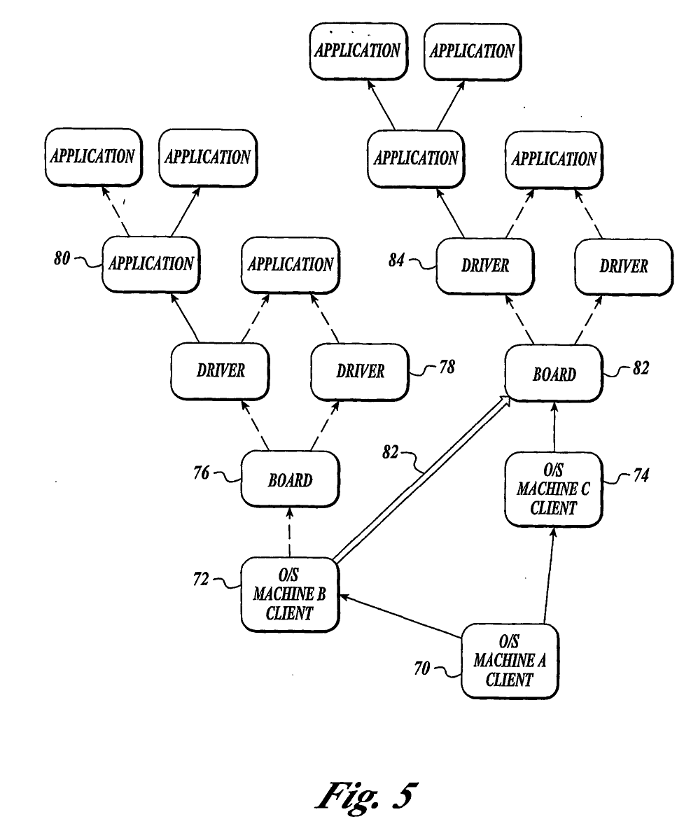

FIG. 5 shows three operating systems that are enabled to manage components. Machine A 70 has been nominated as the manager by the machine entities B and C 72 and 74. Entities B and C are then the client entities. The machines in this configuration are controlling three types of components; electronic circuit boards 76 (also known as cards), drivers 78, which are the interface between the boards and the applications, and the applications such as 80. The dashed line shows a critical dependency and the solid line shows a non-critical dependency. The double lines 86 show that Machine B has the capability to take over and controls board 82 if machine C 74 fails. A critical dependency is one in which if one component fails because of a fault then any other component that may fail due to its dependency on the component with the fault has, what is termed, a critical dependency. Board 76 has a critical dependency on the operating system (O/S) 70. The double line 86 shows that the Machine B operating system can take over board 82 if the Machine C operating system fails.

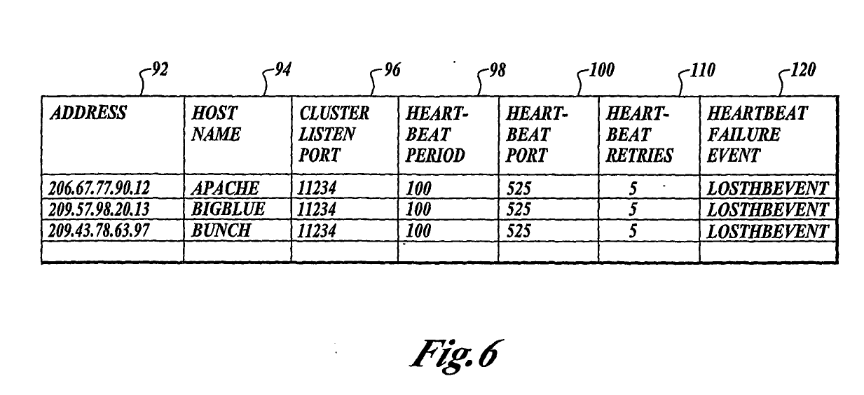

FIG. 6 shows how the component management database may be configured to generate an event in case of a component fault. There is the IP address of the host 92, the name 94 of the host, the cluster listen port 96 defined as the network port on which the component management system sends and receives broadcast messages. This port is the same for all the component management systems in the cluster. Next is the heartbeat period 98 expressed in milliseconds the inverse of which is how often the heartbeat pulse should be generated per second. Heartbeats are periodic signals sent from one component to another to show that the sending unit is still functioning correctly. Then there is the heartbeat port 100, which is the network port on which the component management database receives heartbeats from the cluster manager. The next field is the heartbeat retries 110 which is the number of consecutive heartbeats sent to the component management system that must be lost before the cluster manager considers the client component management system to be lost. The last field 120 tells the system what event to be published when the number of heartbeat retries has elapsed.

This system of managing components, nodes and clusters using a common database of information that can be replicated and resident on multiple networks allows systems to be managed in an effective manner which in turn permits the system to demonstrate a high availability with a minimum amount of downtime.

Although the present invention has been described in considerable detail with reference to certain preferred versions thereof, other versions are possible. Therefore, the spirit and scope of the invention should not be limited to the description of the preferred versions contained herein.

We claim:

1. A method for maximizing the availability of a computer controlled system, said system including both hardware and software components, comprising:
a) receiving messages describing the components capabilities and the dependencies said components have upon each other;
b) maintaining a database of said capabilities and dependencies using said received messages;
c) receiving an event notification, from one or more said components, pertaining to an event effecting the availability of the system to perform in a successful manner; and
d) managing the interoperability of said components using methods individually determined by the type of component to be managed whereby the goal of maximizing the availability of said system is achieved.

2. The method of claim 1 wherein the event effecting the availability of the system to perform in a successful manner includes the extraction and insertion of peripheral hardware components.

3. The method of claim 2 wherein the peripheral hardware component includes a network interface card.

4. The method of claim 1 wherein a database of said dependencies is established upon initialization of the system.

5. The method of claim 1 wherein the event effecting the availability of the system to perform in a successful manner includes either component performance degradation or component failure.

6. A method for maximizing the availability of multiple computer systems linked together, said systems including both hardware and software components, comprising:
a) receiving messages describing the components capabilities and the dependencies said components have upon each other;
b) maintaining a database of said capabilities and dependencies using said received messages;
c) receiving an event notification, from one or more said components, pertaining to an event effecting the availability of the system to perform in a successful manner; and
d) managing the interoperability of said components using methods individually determined by the type of component to be managed whereby the goal of maximizing the availability of said system is achieved.

7. The method of claim 6 wherein the event effecting the availability of the system to perform in a successful manner includes the extraction and insertion of hardware components.

8. The method of claim 6 wherein the hardware component includes a network interface card.

9. The method of claim 6 wherein a database of said dependencies is established upon initialization of the system and said database is replicated and persisted across the multiple computer systems.

10. The method of claim 6 wherein the event effecting the availability of the networked systems to perform in a successful manner includes either component performance degradation or component failure.

11. A system for maximizing the availability of multiple computer systems linked together, said multiple computer systems including both hardware and software components, comprising:
a) a dynamic configuration manager receiving messages describing the components capabilities and the dependencies said components have upon each other;
b) a distributed messaging service incorporating the capability of passing messages through packet filtering and proxy firewalls;
c) a component management database maintaining a table of said capabilities and dependencies using said messages; and
d) a set of methods to manage the interoperability of said components, each method individually determined by the type of component to be managed, whereby the goal of maximizing the availability of said system is achieved

12. A system for maximizing the availability of multiple computer systems, linked together, said multiple computer systems including both hardware and software components, comprising:
a) means for configuring a database of management information, said information including the types of components that comprise the system, the projected role that each component plays in the system, the actual role that the component plays in the system and the interrelationship each component has with each other;
b) means for establishing methods to monitor and control said software and hardware components, the methods tailored to the particular class of component of interest;
c) means for receiving messages and notifications from the components so that the appropriate methods may be invoked to maximize the availability of the system in which that component resides; and
d) means for replicating and persisting the data, residing in the database of management information, across both the system and the network.
